(19) United States
(12) Patent Application Publication
(10) Pub. No.: US 2015/0343811 A1
(43) Pub. Date: Dec. 3, 2015

(54) MECHANISM AND METHOD FOR ADJUSTING TENSION OF BELT FOR PRINTER HEAD MODULE OF PRINTER SUPPORTED ON A PULLEY

(71) Applicant: Hon Hai Precision Industry Co., Ltd., New Taipei (TW)

(72) Inventors: Kung-Huang Tsai, New Taipei (TW); Chang-Hsiu Wu, New Taipei (TW); Hui-Huang Lin, New Taipei (TW); Pei-Yi Chan, New Taipei (TW); Pei-Jung Lee, New Taipei (TW)

(73) Assignee: Hon Hai Precision Industry Co., Ltd., New Taipei (TW)

(21) Appl. No.: 14/289,119

(22) Filed: May 28, 2014

(51) Int. Cl. B41J 15/16

(52) U.S. Cl. CPC B41J 15/16

(57) ABSTRACT

A tension adjusting mechanism for a toothed belt for driving a printer head of an inkjet printer is disclosed. The tension adjusting mechanism includes a housing secured to a frame of the printer. An electromagnet is secured to the housing, and a magnet movably is received in the housing and is repulsed by the electromagnet. A linkage is drivably connected with the magnet and a pulley is drivably connected with the linkage. The toothed belt engages with a circumferential periphery of the pulley. The adjustment of the tension force of the toothed belt is achieved by changing a current applied to the electromagnet to change the repulsive force of the electromagnet acting on the magnet.

### FIELD

The present disclosure relates to a tension adjusting mechanism and method of a belt for a printer head module of a printer, and, more particularly to a tension adjusting mechanism and method of a belt for a printer head module of an inkjet printer.

### BACKGROUND

Printers are widely used as information output terminals for computers. Inkjet printers have become more and more popular due to their advantages regarding the price and printing quality. A printer head module of an inkjet printer is driven by a servomotor via a toothed belt to reciprocate laterally along a shaft to print information on paper by a printer head of the printer head module. A tension of the toothed belt is vital to the precise operation of the printer head module. If the tension of the toothed belt is too low, an engagement between the toothed belt and an output shaft of the servomotor may be loosened whereby a precise movement of the printer head module cannot be obtained and the printer head cannot print precisely the required information on the paper. If the tension is too high, a too large force is exerted to the output shaft of the servomotor, which hinders a smooth operation of the servomotor and may cause the motor to delay its motion when it is started or during the printing process. Accordingly, the precise printing by the printer head is also adversely affected.

To adjust the tension of the toothed belt to the required value, conventionally a jig is used. After the tension is adjusted to the required value, a pulley around which the toothed belt is extended is fixed to a frame on which the printer head module is affixed. Alternatively, a compression spring is used which exerts an expansion force to the toothed belt for maintaining the required tension of the toothed belt during the printing process. The use of the tension adjusting jig is time-consuming, meanwhile the expansion force of the spring is not easy to control, and the test of the spring for obtaining the required tension of the toothed belt is laborious.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present mechanism and method for adjusting a tension of a toothed belt for a printer head module of a printer. Moreover, in the drawings, like reference numerals designate corresponding parts throughout the several views.

FIG. 1 is a perspective view showing a printer head assembly in accordance with an embodiment of the present disclosure.

FIG. 2 is an exploded view of a mechanism for adjusting a tension of a toothed belt of the printer head assembly of FIG. 1.

FIG. 3 is a top view of the tension adjusting mechanism in engagement with the toothed belt.

### DETAILED DESCRIPTION OF EMBODIMENTS

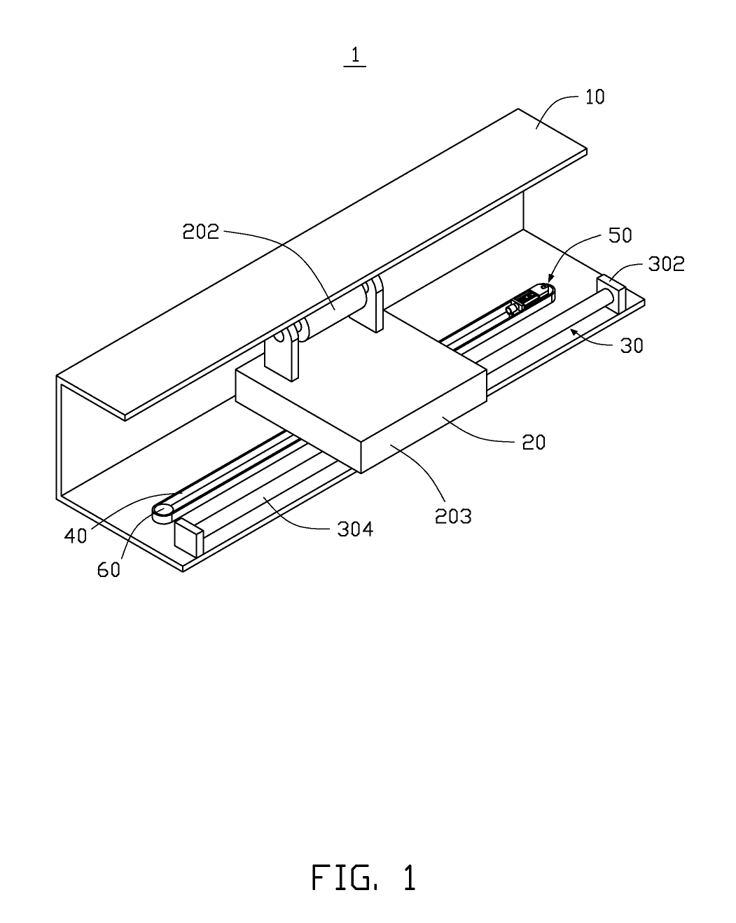

Referring to FIG. 1, a printer head assembly 1 in accordance with the present disclosure includes a frame 10, a printer head module 20, a carrier 30 for supporting and guiding the printer head module 20, a toothed belt 40 for driving a movement of the printer head module 20, a tension adjusting mechanism 50 for adjusting a tension of the toothed belt 40 and a servomotor 60 for driving a movement of the toothed belt 40. The printer head module 20 has a printer head 203 which can inject ink on paper to print information on the paper. The printer head module 20 further has an adjustor 202 for adjusting a position of the printer head 203 to keep a predetermined space between the printer head 203 and the paper to be printed on, whereby the printer head 203 can precisely print information on paper with different thicknesses such as plain paper or photographic paper. In the drawings, only an output shaft of the servomotor 60 is shown, which has a plurality of teeth on a circumferential periphery thereof. The teeth engage with teeth formed on an inner surface the toothed belt 40 at a left end thereof, whereby when the output shaft of the servomotor 60 rotates by a driving of the servomotor 60, the toothed belt 40 rotates accordingly.

The carrier 30 has two spaced brackets 302 secured on a left end and a right end of the frame 10 and a round shaft 304 fixed to and extending between the two brackets 302. The printer head module 20 is slideably engaged with the round shaft 304, and has a belt-attachment (not shown) engaging with the teeth of the toothed belt 40, whereby when the toothed belt 40 is driven by the servomotor 60 to rotate, the printer head module 20 and accordingly the printer head 203 are driven by the toothed belt 40 to reciprocate laterally along the round shaft 304 between the two brackets 302. When the toothed belt 40 rotates clockwise, as shown in FIG. 1, the printer head module 20 together with the printer head 203 moves rightwards. When the toothed belt 40 rotates counterclockwise, the printer head module 20 together with the printer head 203 moves leftwards.

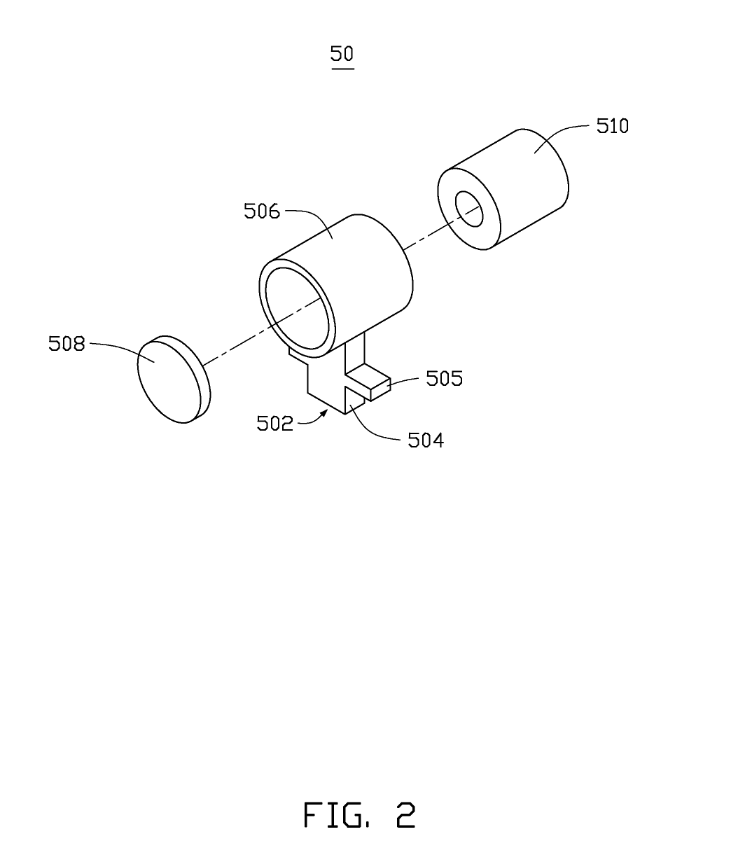

Referring to FIG. 2, the tension adjusting mechanism 50 includes a housing 502 having a leg 504 and a tube 506 mounted on a top of the leg 504. The leg 504 is secured to the frame 10. The leg 504 has two protrusions 505 on front and rear sides thereof, respectively. The two protrusions 505 engage in the frame 10 to reinforce the secure connection between the leg 504 and the frame 10. The tube 506 is horizontally oriented. An electromagnet 508 is fixed at a left end and a magnet 510 is moveably received in the tube 506 and located at a right side of the electromagnet 508. The magnetic force generated by the electromagnet 508 is adjustable by adjusting a current applied thereto. The electromagnet 508 and the magnet 510 are so arranged that they are repulsive to each other, whereby the magnet 510 is pushed by the electromagnet 508 to move rightwards.

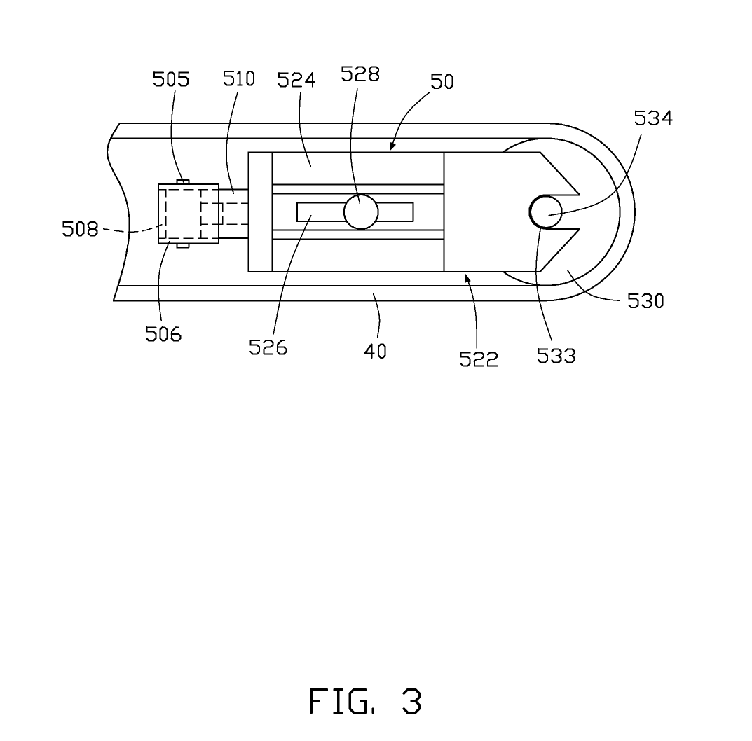

Referring to FIG. 3, the belt tension adjusting mechanism 50 further includes a pulley module 522 consisting of a linkage 524 and a pulley 530. The linkage 524 defines an elongated slot 526 therein, which extends lengthwise between left and right ends of the linkage 524. A bolt 528 extends vertically through the slot 526 and is movable therealong when the bolt 528 is loosened from a nut (not shown) under the frame 10. The linkage 524 has a left end engaging with the magnet 510 and a right end having a fork-like shape defining a recess 533 therein. The pulley 530 has a central axle 534 received in the recess 533. The pulley 530 is rotatable around the axle 534. The pulley 530 has a circumferential periphery defining a plurality of teeth engaging with the teeth on the inner surface of the toothed belt 40 at a right end thereof.

To adjust the tension of the toothed belt 40, the bolt 528 is loosened from the nut and the current applied to the electromagnet 508 is changed to change the magnetic force generated by the electromagnet 508. The change of the of the magnetic force generated by the electromagnet 508 changes the amount of the pushing force of the electromagnet 508 acting on the magnet 510 which, in turn, changes a force of the linkage 524 pushing the pulley 530 via the axle 534 toward the toothed belt 40. Accordingly, the tension of the toothed belt 40 is changed. For example, when the current applied to the electromagnet 508 is increased, the pushing force acting on the magnet 510 by the electromagnet 508 is increased, whereby the force that the magnet 510 pushes the pulley 530 via the linkage 524 and the axle 534 toward the toothed belt 40 is increased to increase the tension of the toothed belt 40. When the tension of the toothed belt 40 is adjusted to the required level, the bolt 528 is rotated to tightly engage the nut to securely fix linkage 524 to the frame 10 thereby to maintain the tension of the toothed belt 40 at the required level.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A mechanism for changing a tension of a toothed belt for a printer head of a printer, comprising:
a housing configured to be secured to a frame;
an electromagnet fixed to the housing;
a magnet movably received in the housing;
a linkage engaging with the magnet; and
a pulley having a circumferential periphery configured for engaging with the toothed belt and an axle engaging with the linkage, wherein the pulley is rotatable around the axle;
wherein when a current to the electromagnet is increased, a pushing force acting on the magnet by the electromagnet is increased, whereby a force that the magnet pushes the pulley via the linkage and the axle toward the toothed belt is increased to increase the tension of the toothed belt.

2. The mechanism of claim 1, wherein the housing has a leg configured to be secured to the frame and a tube on the leg, the electromagnet is secured to the tube and the magnet is movably received in the tube and located between the electromagnet and the linkage.

3. The mechanism of claim 2 further comprising a bolt, wherein the linkage defines an elongated slot lengthwise extending between first end and second end of the linkage, the first end engaging with the magnet and the second end engaging with the axle of the pulley, the bolt being configured for securely fixing the linkage to the frame.

4. The mechanism of claim 2, wherein the second end of the linkage defines a recess receiving the axle of the pulley therein.

5. A printer head assembly comprising:
a frame;
a carrier fixed on the frame;
a printer head module reciprocably movably mounted on the carrier, the printer head module having a printer head configured for printing information on a sheet;
a toothed belt drivably engaging with the printer head module for driving the printer head module together with the printer head to move along the carrier; and
a tension adjusting mechanism for adjusting a tension of the toothed belt, comprising:
a housing fixed to the frame;
an electromagnet fixed to the housing;
a magnet slideably received in the housing and pushed by the electromagnet;
a linkage engaging with an end of the magnet away from the electromagnet and pushed by the magnet; and
a pulley pushed by the linkage to engage with the toothed belt at an end thereof;
wherein when a current applied to the electromagnet is changed to change the pushing force of the electromagnet acting on the magnet, the tension of the toothed belt is changed.

6. The printer head assembly of claim 5, wherein an opposite end of the toothed belt is drivably connected to a motor.

7. The printer head assembly of claim 5, wherein the carrier comprises two spaced brackets secured to the frame and a shaft secured to and extending between the two spaced brackets, the printer head module being movably mounted on the shaft.

8. The printer head assembly of claim 5, wherein the housing has a leg secured to the frame and a tube mounted on a top of the leg, the electromagnet being secured to an end of the tube, the magnet being movably received in the tube.

9. The printer head assembly of claim 8, where the leg has two protrusions on two opposite faces thereof, respectively, the protrusions being engaged in the frame for reinforcing the connection between the leg and the frame.

10. The printer head assembly of claim 5, wherein the pulley has an axle and the pulley is rotatable about the axle, the axle benign engaged with the linkage.

11. The printer head assembly of claim 10, wherein the linkage defining a recess at an end thereof which is distant from the magnet, the axle being received in the recess.

12. The printer head assembly of claim 10 further comprising a bolt, wherein the linkage defines a slot, the bolt extending in the slot and configured to secure to the linkage to the frame.

13. A method for tensioning a toothed belt for driving a printer head of a printer using an electromagnet, comprising:
providing an electromagnet, a magnet receiving a repulsive force generated by the electromagnet, a linkage drivably connected with the magnet and a pulley drivably connected with the linkage, wherein the pulley is configured for engaging with the toothed belt;
adjusting amount of current applied to the electromagnet to adjust the repulsive force of the electromagnet acting on the magnet to adjust a pushing force acting on the toothed belt by the pulley thereby to adjust the tension of the toothed belt; and
fixing the linkage at a determined position when the tension of the toothed belt reaches a required level.

14. The method of claim 13, wherein the pulley has an axle around which the pulley is rotatable, the linkage defining a recess, the axle being received in the recess and engaged with the linkage.

15. The method of claim 13, wherein the linkage defines an elongated slot lengthwise extending between the magnet and the pulley, the step of fixing the linkage being achieved by extending a bolt in the slot and securing the bolt to an object.

16. A drive belt tensioning mechanism configured to be incorporated into a printer having a belt-driven reciprocating printing head, the mechanism comprising:
a printing head drive belt support pulley configured to be coupled to the printer by a take-up mechanism configured to maintain an associated printing head drive belt in tension during printer operation; and
the take-up mechanism comprising an electromagnet operatively coupled to the printing head drive belt support pulley and configured to exert a biasing force thereupon during printer operation.

17. The drive belt tensioning mechanism of claim 16, wherein the take-up mechanism further comprises a magnet which is pushed by the electromagnet to exert the biasing force upon the printing head drive belt support pulley.

18. The drive belt tensioning mechanism of claim 17, wherein the take-up mechanism further comprises a tube, the electromagnet is fixed to an end of the tube away from the printing head drive belt support pulley and the magnet is slideably received in the tube between the electromagnet and the printing head drive belt support pulley.

19. The drive belt tensioning mechanism of claim 18, wherein the take-up mechanism further comprises a linkage located between the magnet and the printing head drive belt support pulley, the linkage formed a fork-shaped end, an axle of the printing head drive belt support pulley being received in the fork-shaped end of the linkage.
